(19) United States
(12) Patent Application Publication
(10) Pub. No.: US 2011/0253831 A1
(43) Pub. Date: Oct. 20, 2011

(54) Foldable rotor blade for toy helicopter

(76) Inventor: Randy Cheng, San Gabriel, CA (US)

(21) Appl. No.: 12/799,183

(22) Filed: Apr. 19, 2010

(51) Int. Cl. B64C 27/54; B64C 27/50; B64C 27/82

(52) U.S. Cl. 244/17.21; 244/17.11; 416/142

(57) ABSTRACT

A toy helicopter includes a body, a rotor arrangement for generating a rotational power, and a foldable propeller blade including a bracket member coaxially mounted to the rotor arrangement and at least two blade leafs pivotally and symmetrically coupling with the bracket member in a horizontally movable manner to generate an evenly rotational motion thereof, so as to stably provide an upward force to lift up said body. When one of the blade leafs is pivotally folded by an external force to misalign the blade leafs with each other, the bracket member is kept rotating to generate a centrifugal force to essentially re-situate the blade leafs in line with each other so as to re-gain a control and balance of the body.

### BACKGROUND OF THE PRESENT INVENTION

1. Field of Invention

The present invention is related to a toy helicopter, and more particularly, but not exclusively, to a structure of propeller blade of a toy helicopter adapted for being folded when an external force is applied thereat and for being unfolded by itself during operation.

2. Description of Related Arts

The toy helicopter normally has a driven rotor for driving a rotor shaft to move in a rotational manner, and a propeller blade arrangement coaxially coupling with the rotor shaft for being driven to generate a rotational movement, in such a manner that the propeller blade generates an opposite trust force to upwardly lift up the toy helicopter. The propeller blade arrangement may also be arranged to be controllably driven to adjust the steering direction of the toy helicopter. Therefore, the toy helicopter is able to take off and land in a vertical manner via the propeller blade to increase the mobility and flexibility of the toy helicopter, so that the toy helicopter has become extremely popular and practical especially when the place for performing the fly of toy helicopter is limited.

The toy helicopter is not only popular in entertainment, but also in sports. In order to provide the common consumers the fun of controlling toy helicopter and experiencing steering the helicopter, many remotely controlling helicopter toys for being remotely controlled via a remote controller have been greatly manufactured. No matter operating the toy helicopter entertainment, such as the above mentioned helicopter toys, or any other purposes, it all requires highly intense training or learning process.

Finding out the ways for simplifying the operation of toy helicopter have been intensely studied. Take the toy helicopter for example. The common problem for the beginners to control the remotely controlled helicopter is the highly possibility of crushing the toy helicopter due to the unwanted movements, such as lateral movement, to destroy the balance of the toy helicopter flying in the air. Moreover, the inexperienced beginners may have a hard time to controllably steer the toy helicopter toward the desired directions. Therefore, the propeller blade, having a larger rotational radius with respect to the helicopter body itself, tends to easily hit an object, so that the entire propeller blade fixedly mounted at the rotor shaft may be broken, deformed, destroyed, or tilted, so as to lose the gravity of the helicopter in the air to accidentally drop off the helicopter.

As a result, how to enhance the durability and how to automatically compensate an unwanted external forces, such as the resistance torque of the helicopter body, and automatically stabling the helicopter is still way to go. In accordance to the existing problems, the present invention provides a relatively more durable propeller blade to reduce the possibility of breaking the blade and is able to automatically readjust the propeller blade to a balanced position, so that it is easy for the consumer, especially an inexperienced beginner, to get started with controlling the remotely controlled toy helicopter.

### SUMMARY OF THE PRESENT INVENTION

The invention is advantageous in that it provides a foldable propeller blade mainly, but not exclusively, for toy helicopter, which is able to be pivotally folded to absorb an unwanted external impact force, so as to reduce the damage rate thereof.

Another advantage of the present invention is to provide a foldable propeller blade for toy helicopter, wherein two blade leafs are able to automatically and pivotally situate essentially in line with each other via a centrifugal force to form a evenly rotational motion thereof, so as to automatically re-gain the control and balance of the toy helicopter after the unwanted external impact force applied on the propeller blade.

Another advantage of the present invention is to provide a foldable propeller blade for toy helicopter, wherein the U-shaped hinge joints of the bracket member enable the blade leafs pivotally moving along the rotor shaft to align with each other for evenly providing the upward force and limiting the rotational angle of each of the blade leafs, so as to prevent the blade leafs rotatably move toward each other to bump therewith.

Another advantage of the present invention is to provide a toy helicopter, wherein two sets of the foldable propeller blades are coaxially coupling with the rotor shaft and the auxiliary shaft respectively, so that one of the foldable propeller blades is mainly responsible for providing the upward force, while the other foldable blade is responsible for providing both upward movement and controlling the direction and balance of the toy helicopter, so as to more stably control the helicopter.

Additional advantages and features of the invention will become apparent from the description which follows, and may be realized by means of the instrumentalities and combinations particular point out in the appended claims.

According to the present invention, the foregoing and other objects and advantages are attained by providing a toy helicopter, which comprises:
a body having a body portion;
a rotor arrangement, which comprises a power rotor accommodated within the body portion, wherein the power rotor is powered to controllably and rotatably drive a power rotor shaft to rotate; and
a foldable propeller blade comprising a bracket member coaxially mounted on the power rotor shaft and at least two blade leafs pivotally and symmetrically coupling with the bracket member in a horizontally movable manner to generate an evenly rotational motion thereof, so as to stably provide an upward force to lift up the body. Accordingly, when one of the blade leafs is pivotally folded by an external force to misalign the blade leafs with each other, the bracket member is kept rotating to generate a centrifugal force to essentially re-situate the blade leafs in line with each other so as to re-gain a control and balance of the body.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a toy helicopter according to a preferred embodiment of the present invention.

FIG. 2 is a side sectional view of a foldable propeller blade for the toy helicopter according to the preferred embodiment of the present invention.

FIGS. 3A to 3C are top views of the foldable propeller blade for the toy helicopter according to the preferred embodiment of the present invention, illustrating the pivotally rotating angle of the blade leaf.

FIG. 4 is a perspective view of double foldable propeller blade for a toy helicopter according to the preferred embodiment of the present invention.

### DETAILED DESCRIPTION OF THE PREFERRED EMBODIMENT

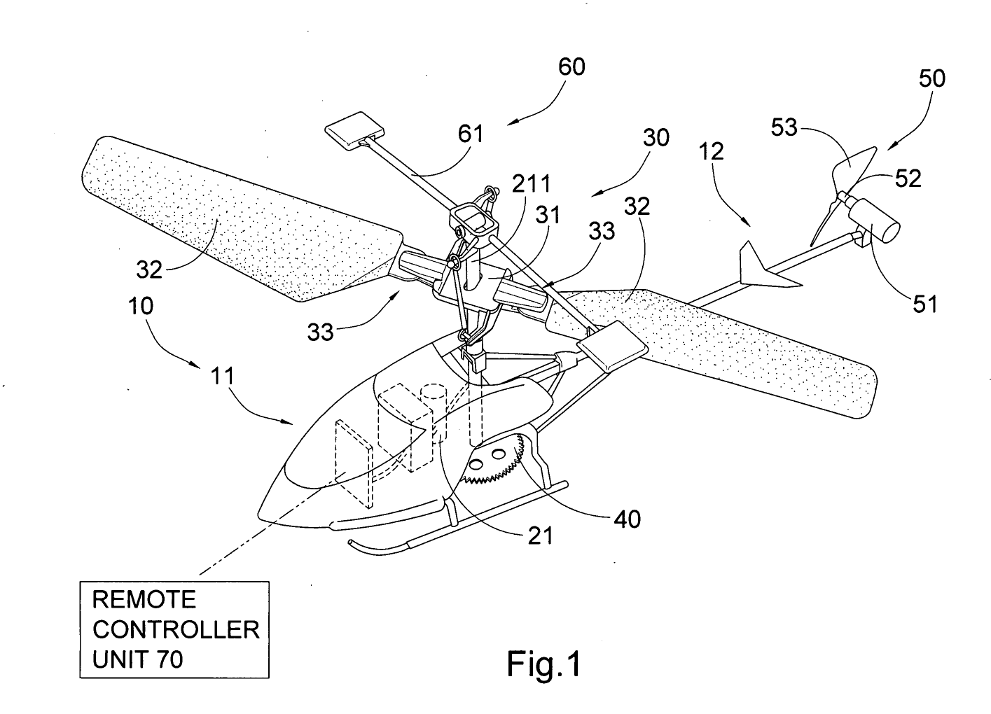

Referring to FIGS. 1 to 3 of the drawings, a toy helicopter according to the preferred embodiment of the present invention, wherein the toy helicopter has a body 10 and a rotor arrangement 20 which comprises a power rotor 21 accommodated within the body 10.

As shown in FIG. 1, the body 10 has a body portion 11 having a housing for accommodating the power rotor 21 therewithin, and a tail portion 12 rearwardly extended from the body portion 11. The power rotor 21 is mechanically engaging with the power rotor shaft 211 such that when the power rotor 21 is activated, the power rotor shaft 211 is driven to rotate for generating a rotational power.

The toy helicopter also comprises a foldable propeller blade 30 coaxially mounted at the power rotor shaft 211, in such a manner that the propeller blade 30 is driven to create a rotational motion for mainly and evenly providing an upward force as a lift force to lift up the body 10 of the toy helicopter, so as to keep the toy helicopter in the air.

According to the preferred embodiment, the toy helicopter further comprises a remote control unit 70 remotely controlling the rotor arrangement 20 to selectively adjust a power output of the power rotor 21 through the power rotor shaft 211 to the foldable propeller blade 30. In other words, a user is able to controllably steer the toy helicopter via the remote control unit 70. For example, through remotely controlling the power rotor 21, the remote control unit 70 can control a rotational speed of the power rotor shaft 211 to control the flying height and speed of the toy helicopter.

According to the preferred embodiment, the propeller blade 30 comprises a bracket member 31 coaxially mounted at the power rotor shaft 211, and at least two blade leafs 32 pivotally coupling at a peripheral edge of the bracket member 31 in an evenly distributed manner. In other words, the two blade leafs 32, for example, are symmetrically formed at the peripheral edge of the bracket member 31. More specifically, the two blade leafs 32 are located at two opposite ends of the bracket member 31, and arranged in such a manner that when the bracket member 31 is driven by the power rotor 21 to rotate about the power rotor shaft 211 as a rotational axis, the blade leafs 32 are rotatably moved to form the rotational movement to generate the lift force for lifting up the body 10, so as to form a rotational plane with respect to the rotational axis of the power rotor shaft 211.

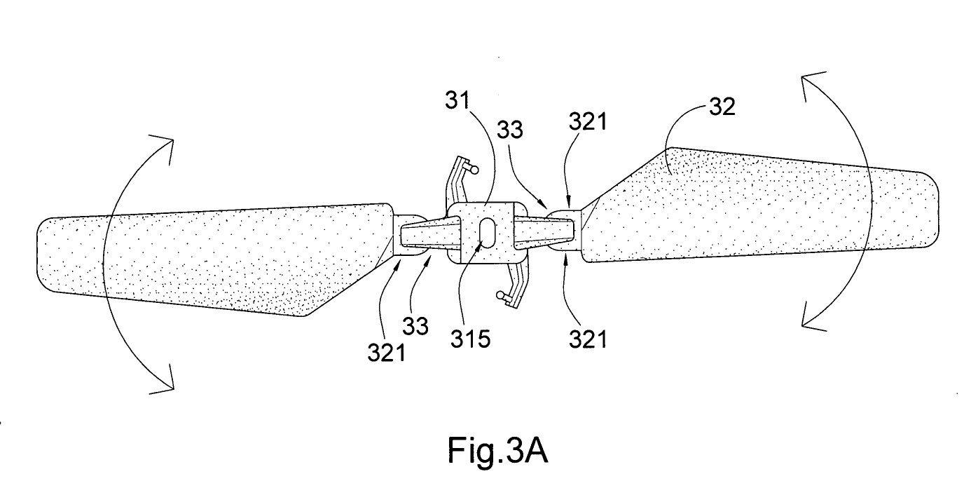

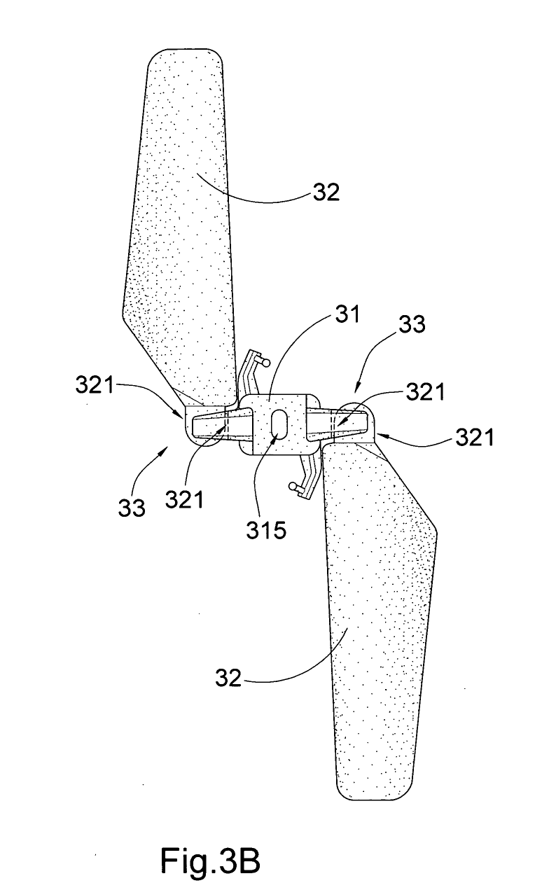

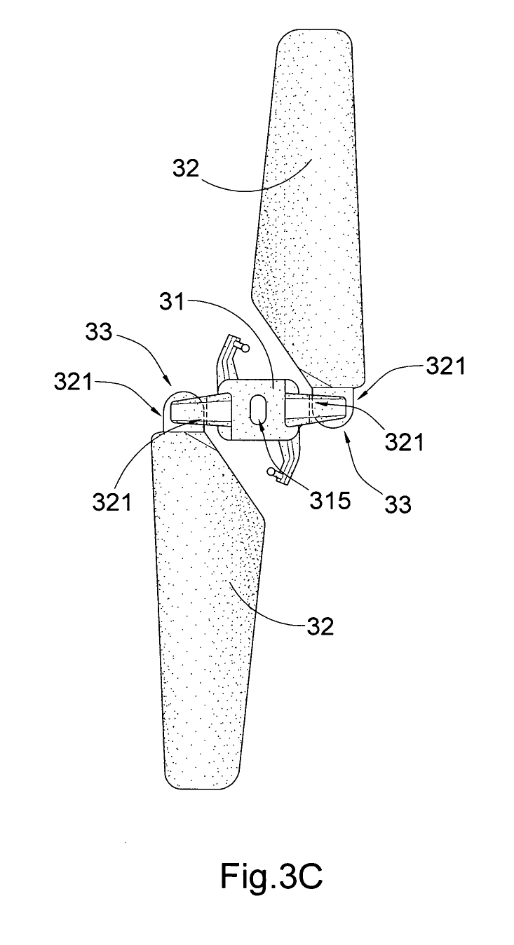

According to the preferred embodiment of the present invention, the blade leafs 32 are pivotally coupled with the bracket member 31 via two hinge joints 33 respectively for enabling the blade leaf 32 being pivotally folded in a 180° horizontal direction, as shown in FIGS. 3A to 3C. The hinge joints 33 are opposedly extended from the peripheral edge of the bracket member 31 to pivotally couple with the inner ends of the blade leafs 32 respectively.

As a result, the blade leafs 32 of the foldable propeller blade 30 are automatically situated in line with each other via the centrifugal force during the rotational movement of the blade leafs 32. In other words, the blades leafs 32 are able to form the rotational motion for evenly distributing and generating the upward force to lift up the body 10 of the toy helicopter, so as to self balance the gravity thereof for being stably lifted up.

Moreover, when an external impact force is unintentionally applied on one of the blade leafs 32 of the propeller blade 30, the blade leaf 32 is able to be pivotally folded via pivotal connection of the respective hinge joint 33. Therefore, the pivotally folded blade leaf 32 can absorb the external impact force to prevent the propeller blade 30 being broke thereby.

On the other hand, after the above external impact force is disappeared, the rotational movement of the foldable propeller blade 30 providing the centrifugal force to the blade leafs 32 enables the blade leafs 32 pivotally moving to a balanced extended position to essentially align the two blade leafs 32 to each other, so as to automatically re-adjust the gravity of the toy helicopter and re-stabilize thereof. In other words, when one of the blade leafs 32 is pivotally folded by the external force to misalign the blade leafs 32 with each other, the bracket member 31 is kept rotating to generate the centrifugal force to essentially re-situate the blade leafs 32 in line with each other for re-gaining a control and balance of the body 10.

For instance, when the foldable propeller blade 30 of toy helicopter accidentally hit an object, such as a wall, to apply a trust force on the blade leaf 32, the blade leaf 32 may be pivotally and rotatably folded to absorb the external impact force, and meanwhile, lead the toy helicopter being deviated from its balanced position to cause an uncontrolled movements. After the external impact force, the pivotally movable blade leafs 32 can shortly return to the stable position by the centrifugal force, which is provided when the power rotor shaft 211 is being driven by the power rotor 21, in such a manner that the toy helicopter is able to be auto-stabilized to simplify operating the toy helicopter.

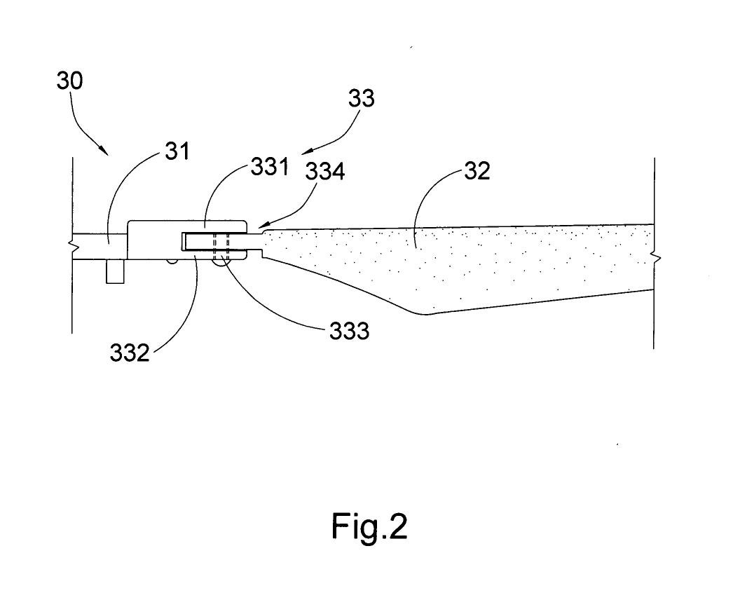

In the preferred embodiment of the present invention, each of the hinge joints 33 preferably has an essentially U-shaped configuration. As shown in FIG. 2, each of the hinge joints 33 comprises upper and bottom walls 331, 332 for the inner end of the respective blade leaf 32 sandwiching therebetween, and a pivot shaft 333 extended between the upper and bottom walls 331, 332 to pivotally couple the inner end of the respective blade leaf 32 between the upper and bottom walls 331, 332.

As shown in FIG. 3, each of the hinge joints 33 has an elongated retention cavity 334 defined between the upper and bottom walls 331, 332, wherein the retention cavity 334 has a three-sided opening configuration for enabling the blade leaf 32 being pivotally folded in a 180° horizontal direction. In particularly, the retention cavity 334 has an outer edge opening for enabling the blade leaf 32 being aligned with another blade leaf 32 to form an in-line structure, as shown in FIG. 3A. The retention cavity 334 also has two side edge openings for enabling the blade leaf 32 being pivotally folded perpendicularly to the bracket member 31 as shown in FIGS. 3B and 3C.

In addition, a distance between the upper and bottom walls 331, 332 is slightly larger than a thickness of the inner end of the respective blade leaf 32 such that when the inner end of the blade leaf 32 is coupled between the upper and bottom walls 331, 332, the blade leaf 32 is retained in a horizontal planar manner.

In order to prevent the over-folding of each of the blade leafs 32, each of the blade leafs 32 has two blocking side edges 321 defined at two sides of the inner end of the blade leaf 32, wherein when the blade leaf 32 is pivotally folded, one of the blocking side edges 321 of the blade leaf 32 is blocked by the wall of the bracket member 32 so as to limit a pivotally rotating angle of the blade leaf 32.

Therefore, the blocking side edges 321 of each of the blade leafs 32 limit a rotational angle of the blade leaf 32 substantially within or about 180°. It is appreciated that the limited rotational angle of the blade leafs 32 prevents the blade leafs 32 bumped with each other to damage thereof, so as to enhance the safety and stability of the toy helicopter.

It is worth to mention that the foldable propeller blade 30 not only can effectively minimize the possibility of breaking or deforming the blade leafs 32 by the external impact force, but also can rapidly return the blade leafs 32 deviated from the balanced position to the symmetrically balanced position of the blade leafs 32 by the centrifugal force thereof. In the preferred embodiment, the symmetrical balanced position of the blade leafs 32 is the two leafs 32 essentially and longitudinally in alignment with each other to extend at two opposite ends of the bracket member 31.

As will be readily appreciated by one skill in the art, the foldable propeller blade 30 may also comprise three or more blade leafs depending on the design of the toy helicopter, in which the blades leafs 32 are also equally angular apart along the peripheral edge of the bracket member 31 for pivotally coupling thereat. Take three blade leafs 32 for example. When the power rotor shaft 211 is driving the three of the blade leafs 32of the foldable propeller blade 30, which are equally spaced apart to couple with the bracket member 30, to rotatably form the rotational plane, the blade leafs 32 are pivotally and automatically extending to a location that two adjacent blade leafs are equally angular apart at a 120°, so as to evenly and symmetrically formed the three blade leafs 32 at the rotational plane.

As mentioned above, the power rotor 21 is preferably to mechanically connect with the power rotor shaft 211 through a gear arrangement 40, wherein the gear arrangement 40 preferably formed via at least a gear to mesh with another gear for transforming the torque force from the power rotor 21 to the rotor shaft 211, so as to remotely control the speed thereof to remotely control the performance of the toy helicopter via the remote control unit 70.

In order to resist a torque force of the toy helicopter formed by a trust of the rotation movement of the foldable propeller blade 30, a tail blade arrangement 50 is provided for overcoming the torque force to balance the helicopter, so as to selectively direct the body 10 toward a desired direction. The tail blade arrangement 50 may comprises a tail rotor 51 supported at the tail portion 12 of the body 10, a tail shaft 52 coaxially mounted at the tail rotor 51 for being mechanically driven to rotate by the tail rotor 51, and at least a tail blade 53 preferably provided at a tail end of the tail portion 12 of the body 10, in which the tail blade 53 is arranged to be rotatably driven by the tail shaft 52, in such a manner that the tail blade 53 is able to create a force against the torque force from the rotational movement of the foldable propeller blade 30.

Accordingly, the bracket member 31 may further has an elongated slot 315 formed at a central portion thereof for coaxially extending through the power rotor shaft 211, so as to coaxially mounted thereat. The elongated slot 315 preferably has a width essentially matching a diameter of the power rotor shaft 211, and preferably has a length slightly larger than the diameter of the power rotor shaft 211, in such a manner that elongated slot 315 enables the bracket member 31 to slightly and rotatably move up and down and constrains the movement of the bracket member 31 within the elongated slot 315. As a result, the rotational plane, formed when the blade leafs 32 are driven by the bracket member 31 to rotate, is able to be adjustably tilted forward or backward in order to adjustably provide a forward or backward force to the body 10, so as to steer the toy helicopter forward or backward. It is worth to mention that a tilted angle of the rotational plane is preferably controlled by the bracket member 31, wherein the bracket member 31 is preferably controlled via a controlling arrangement thereof, such as the conventional control system, so as to control the tilted angle of the rotational plane.

The toy helicopter may further comprises a stabilizing arrangement 60 preferably has a least a stabilizing bar 61 coaxially coupling with the power rotor shaft 211 and at a location above the foldable propeller blade 30, in such a manner that the stabilizing bar 61 is able to auto-readjust the balance with respect to the propeller blade 30, so as to automatically stable the helicopter especially when the toy helicopter is deviated from the balanced position.

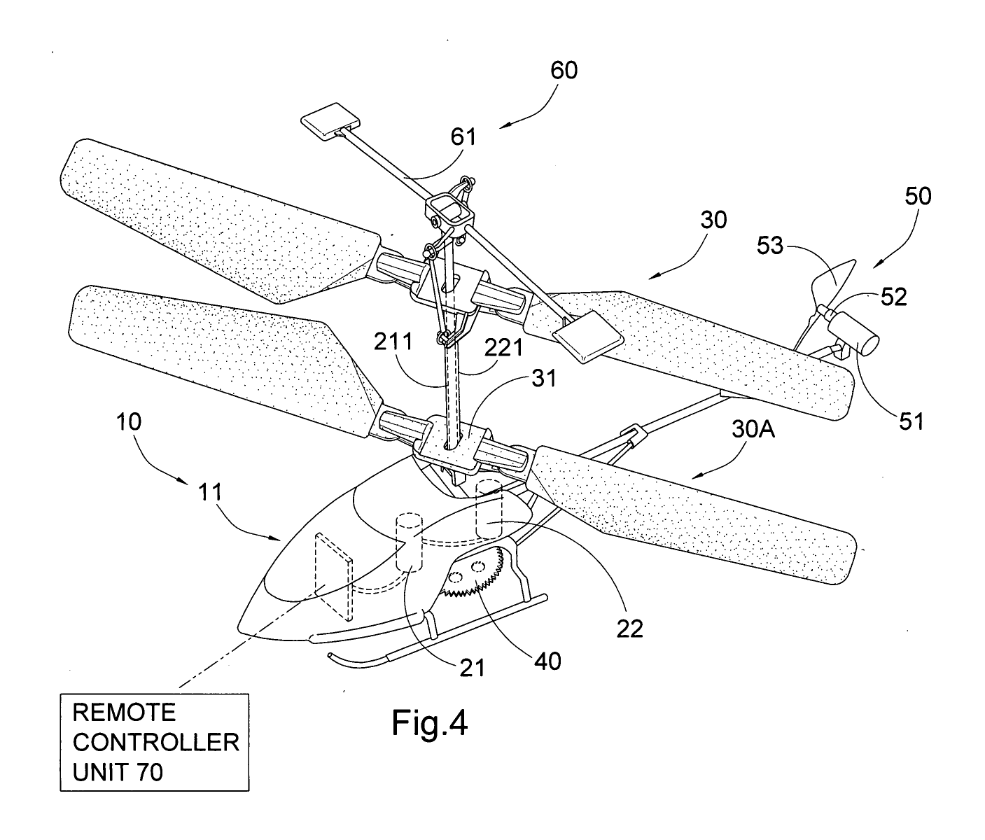

Referring to FIG. 4 of the drawings, a modification of the toy helicopter according to the above preferred embodiment of the present invention is illustrated, wherein the toy helicopter has similar structure and functions as the above preferred embodiment. In this modified toy helicopter, the two foldable propeller blades 30, 30A of the present invention are provided for being applied in a double propeller helicopter system. In the double propeller system toy helicopter, an auxiliary rotor 22 and auxiliary rotor shaft 221 are further provided.

The auxiliary rotor 22 and auxiliary rotor shaft 221 may have the similar structure and relations of the power rotor 21 and the power rotor shaft 211, wherein the auxiliary rotor 22 is also being accommodated within the housing of the body portion 11 of the body and mechanically connecting with the auxiliary rotor shaft 221 for driving it to rotate. The power rotor shaft 211 and auxiliary rotor shaft 221 are preferably coupling with each other in a coaxial manner, and preferably arranged that the power rotor shaft 211 is located vertically above the auxiliary rotor shaft 221.

In other words, the power rotor shaft 211 and the auxiliary rotor shaft 221 are coaxially formed a common rotational axis upwardly extending form the body portion 11, wherein the two foldable propeller blades 30, one of the foldable propeller blades 30 being embodied as an auxiliary foldable propeller blade 30A, are coaxially mounted at the power rotor shaft 211 and the auxiliary rotor shaft 221 respectively, in such a manner that the double propeller blades system is formed.

The foldable propeller blade 30 coupling with the power rotor shaft 21 is coaxially located above the auxiliary foldable propeller blade 30A coupling with the auxiliary rotor shaft 22. The bracket member 31 mounted at the power rotor shaft 21 preferably has the elongated slot 315 for controllably adjusting the tilted angle of the rotation plane of the propeller blade thereat as mentioned above, while the bracket member 31 mounted at the auxiliary rotor shaft 22 preferably has a through hole having a shape and size geographically matching a shape of the auxiliary rotor shaft 22 for essentially fixing the bracket member 31 at the auxiliary rotor shaft 22.

Therefore, the foldable propeller blade 30 is able to slightly inclined within a predetermined range of inclined angle for auto-stabilizing the helicopter via the stabilizing bar 61 of the stabilizing arrangement 60, so as to controllably provide the forward or backward force while balancing the body 10. The auxiliary foldable propeller blade 30A at the auxiliary rotor shaft 22 with the fixedly mounted bracket member 31 is preferably adapted for mainly lifting up the body 10 of the toy helicopter.

As a result, the coaxial double foldable propeller blades 30, 30A being driven by the power and auxiliary rotors 21, 22 respectively are preferably has opposite rotational directions in the asynchronous manner, so that the two foldable propeller blades 30, 30A having opposite rotational directions are able to eliminate or minimize the produced torsion, so as to further stabilize the body 10. It is appreciated that the power rotor shaft 211 may be arranged at a location coaxially below the auxiliary rotor shaft 221 depending on the design and applications of the helicopter. The double propeller system is only illustrated as another example of the foldable propeller blade 30. The foldable propeller blade 30 may also be used for any other helicopter or the similar structure for absorbing unwanted external impact force and/or auto re-stabilizing the helicopter via the centrifugal force.

It is worth to mention that the current invention simplify controlling of toy helicopter, so as to reduce and minimize the requirements for long-standing experience of controllably steering the helicopter via the remote control.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A toy helicopter, comprising:
a body having a body portion;
a rotor arrangement, which comprises a power rotor accommodated within said body portion, wherein said power rotor is powered to controllably and rotatably drive a power rotor shaft to rotate; and
a foldable propeller blade comprising a bracket member coaxially mounted on said power rotor shaft and at least two blade leafs pivotally and symmetrically coupling with said bracket member in a horizontally movable manner to generate an evenly rotational motion thereof, so as to stably provide an upward force to lift up said body, wherein when one of said blade leafs is pivotally folded by an external force to misalign said blade leafs with each other, said bracket member is kept rotating to generate a centrifugal force to essentially re-situate said blade leafs in line with each other so as to re-gain a control and balance of said body.

2. The toy helicopter, as recited in claim 1, wherein each of said blade leafs is pivotally coupled with said bracket member via a hinge joint for enabling said blade leaf being pivotally folded in a 180° horizontal direction.

3. The toy helicopter, as recited in claim 2, wherein each of said hinge joints has a U-shaped configuration and comprises upper and bottom walls for inner end of said respective blade leaf sandwiching therebetween, and a pivot shaft extended between said upper and bottom walls to pivotally couple said inner end of said respective blade leaf between said upper and bottom walls.

4. The toy helicopter, as recited in claim 3, wherein each of said hinge joints has an elongated retention cavity defined between said upper and bottom walls, wherein said retention cavity has a three-sided opening configuration for enabling said blade leaf being pivotally folded in a 180° horizontal direction, wherein a distance between said upper and bottom walls is slightly larger than a thickness of said inner end of said respective blade leaf such that when said inner end of said blade leaf is coupled between said upper and bottom walls, said blade leaf is retained in a horizontal planar manner.

5. The toy helicopter, as recited in claim 1, wherein each of said blade leafs has two blocking side edges arranged in such a manner that when said blade leaf is pivotally folded, one of said blocking side edges of said blade leaf is blocked by said bracket member so as to limit a pivotally rotating angle of said blade leaf.

6. The toy helicopter, as recited in claim 2, wherein each of said blade leafs has two blocking side edges arranged in such a manner that when said blade leaf is pivotally folded, one of said blocking side edges of said blade leaf is blocked by said bracket member so as to limit a pivotally rotating angle of said blade leaf.

7. The toy helicopter, as recited in claim 4, wherein each of said blade leafs has two blocking side edges arranged in such a manner that when said blade leaf is pivotally folded, one of said blocking side edges of said blade leaf is blocked by said bracket member so as to limit a pivotally rotating angle of said blade leaf.

8. The toy helicopter, as recited in claim 1, further comprising a remote control unit remotely controlling said rotor arrangement to selectively adjust a power output through said power rotor shaft to said foldable propeller blade.

9. The toy helicopter, as recited in claim 3, further comprising a remote control unit remotely controlling said rotor arrangement to selectively adjust a power output through said power rotor shaft to said foldable propeller blade.

10. The toy helicopter, as recited in claim 7, further comprising a remote control unit remotely controlling said rotor arrangement to selectively adjust a power output through said power rotor shaft to said foldable propeller blade.

11. The toy helicopter, as recited in claim 3, further comprising a stabilizing bar coaxially coupling at an upper end of said power rotor shaft for auto-stabilizing said body, wherein said body further has a tail portion, wherein a tail blade is coupled at said tail portion and controllably powered by a tail rotor of said rotor arrangement.

12. The toy helicopter, as recited in claim 10, further comprising a stabilizing bar coaxially coupling at an upper end of said power rotor shaft for auto-stabilizing said body, wherein said body further has a tail portion, wherein a tail blade is coupled at said tail portion and controllably powered by a tail rotor of said rotor arrangement.

13. The toy helicopter, as recited in claim 1, further comprises an auxiliary rotor shaft coaxially coupling with said power rotor shaft to form a common rotational axis extended upwardly from said body portion, an auxiliary rotor being powered to drive said auxiliary rotor shaft to rotate, and an auxiliary foldable propeller blade, which has the same structure of said foldable propeller blade, coupled at said auxiliary rotor shaft and spaced apart from said foldable propeller blade, such that when said auxiliary rotor shaft is driven to rotate via said auxiliary rotor, said auxiliary foldable propeller blade is driven to generate a rotational motion so as to form a double propellers system.

14. The toy helicopter, as recited in claim 7, further comprises an auxiliary rotor shaft coaxially coupling with said power rotor shaft to form a common rotational axis extended upwardly from said body portion, an auxiliary rotor being powered to drive said auxiliary rotor shaft to rotate, and an auxiliary foldable propeller blade, which has the same structure of said foldable propeller blade, coupled at said auxiliary rotor shaft and spaced apart from said foldable propeller blade, such that when said auxiliary rotor shaft is driven to rotate via said auxiliary rotor, said auxiliary foldable propeller blade is driven to generate a rotational motion so as to form a double propellers system.

15. The toy helicopter, as recited in claim 12, further comprises an auxiliary rotor shaft coaxially coupling with said power rotor shaft to form a common rotational axis extended upwardly from said body portion, an auxiliary rotor being powered to drive said auxiliary rotor shaft to rotate, and an auxiliary foldable propeller blade, which has the same structure of said foldable propeller blade, coupled at said auxiliary rotor shaft and spaced apart from said foldable propeller blade, such that when said auxiliary rotor shaft is driven to rotate via said auxiliary rotor, said auxiliary foldable propeller blade is driven to generate a rotational motion so as to form a double propellers system.

16. A foldable propeller blade for a toy helicopter which comprises a power rotor supported at a body, comprising:
a bracket member arranged for coaxially mounting at a power rotor shaft of said power rotor;
two blade leafs symmetrically and opposedly extending from said bracket member for generating an evenly rotational motion to stably provide an upward force to lift up said body; and
two hinge joints pivotally coupling inner ends of said blade leafs with said bracket member, wherein when one of said blade leafs is pivotally folded by an external force to misalign said blade leafs with each other, said bracket member is kept rotating to generate a centrifugal force to essentially re-situate said blade leafs in line with each other for re-gaining a control and balance of said body.

17. The foldable propeller blade, as recited in claim 16, wherein each of said hinge joints has a U-shaped configuration and comprises upper and bottom walls for said inner end of said respective blade leaf sandwiching therebetween, and a pivot shaft extended between said upper and bottom walls to pivotally couple said inner end of said respective blade leaf between said upper and bottom walls.

18. The foldable propeller blade, as recited in claim 17, wherein each of said hinge joints has an elongated retention cavity defined between said upper and bottom walls, wherein said retention cavity has a three-sided opening configuration for enabling said blade leaf being pivotally folded in a 180° horizontal direction, wherein a distance between said upper and bottom walls is slightly larger than a thickness of said inner end of said respective blade leaf such that when said inner end of said blade leaf is coupled between said upper and bottom walls, said blade leaf is retained in a horizontal planar manner.

19. The foldable propeller blade, as recited in claim 16, wherein each of said blade leafs has two blocking side edges arranged in such a manner that when said blade leaf is pivotally folded, one of said blocking side edges of said blade leaf is blocked by said bracket member so as to limit a pivotally rotating angle of said blade leaf.

20. The foldable propeller blade, as recited in claim 18, wherein each of said blade leafs has two blocking side edges arranged in such a manner that when said blade leaf is pivotally folded, one of said blocking side edges of said blade leaf is blocked by said bracket member so as to limit a pivotally rotating angle of said blade leaf.
